(19) United States
(12) Patent Application Publication
(10) Pub. No.: US 2013/0022873 A1
(43) Pub. Date: Jan. 24, 2013

(54) HIGH-POWER NANOCOMPOSITE CATHODES FOR LITHIUM ION BATTERIES

(71) Applicants: Jon Fold von Bulow, Soborg (DK); Hong-Li Zhang, Goleta, CA (US); Daniel E. Morse, Santa Barbara, CA (US)

(72) Inventors: Jon Fold von Bulow, Soborg (DK); Hong-Li Zhang, Goleta, CA (US); Daniel E. Morse, Santa Barbara, CA (US)

(73) Assignee: THE REGENTS OF THE UNIVERSITY OF CALIFORNIA, Oakland, CA (US)

(21) Appl. No.: 13/553,366

(22) Filed: Jul. 19, 2012

Related U.S. Application Data
(60) Provisional application No. 61/509,516, filed on Jul. 19, 2011.

(51) Int. Cl. H01M 4/64; H01M 4/525; H01M 4/485; H01M 4/62; H01M 4/505; B82Y 30/00

(52) U.S. Cl. 429/221; 429/233; 429/232; 429/224; 429/223; 429/231.3; 429/231.1; 252/500; 252/502; 252/519.1; 252/519.15; 252/519.14; 977/742; 977/752; 977/750; 977/948; 977/734

(57) ABSTRACT

A method of growing electrochemically active materials in situ within a dispersed conductive matrix to yield nanocomposite cathodes or anodes for electrochemical devices, such as lithium-ion batteries. The method involves an in situ formation of a precursor of the electrochemically active materials within the dispersed conductive matrix followed by a chemical reaction to subsequently produce the nanocomposite cathodes or anodes, wherein: the electrochemically active materials comprise nanocrystalline or microcrystalline electrochemically active metal oxides, metal phosphates or other electrochemically active materials; the dispersed conductive matrix forms an interconnected percolation network of electrically conductive filaments or particles, such as carbon nanotubes; and the nanocomposite cathodes or anodes comprise a homogeneous distribution of the electrochemically active materials within the dispersed conductive matrix.

### CROSS REFERENCE TO RELATED APPLICATIONS

This application claims the benefit under 35 U.S.C. Section 119(e) of co-pending and commonly assigned U.S. Provisional Patent Application Ser. No. 61/509,516, filed on Jul. 19, 2011, by Jon Fold von Bulow et al., entitled “HIGH-POWER NANOCOMPOSITE CATHODES FOR LITHIUM ION BATTERIES,” attorney's docket number 30794.414-US-P2 (2011-769-2);

which application is incorporated by reference herein.

This application is related to the following co-pending and commonly-assigned applications:

P.C.T. International Patent Application Serial No. US2010/025944, filed on Mar. 2, 2010, by Hong-Li Zhang and Daniel E. Morse, entitled “METHOD FOR PREPARING UNIQUE COMPOSITION HIGH PERFORMANCE ANODE MATERIALS FOR LITHIUM ION BATTERIES,” attorney's docket number 30794.307-WO-U1 (2009-491-2), which application claims the benefit under 35 U.S.C. Section 119(e) of co-pending and commonly assigned U.S. Provisional Patent Application Ser. No. 61/156,774, filed on Mar. 2, 2009, by Hong-Li Zhang and Daniel E. Morse, entitled “METHOD FOR PREPARING UNIQUE COMPOSITION HIGH PERFORMANCE ANODE MATERIALS FOR LITHIUM ION BATTERIES,” attorney's docket number 30794.307-US-P1 (2009-491-1);

which applications are incorporated by reference herein.

### STATEMENT REGARDING FEDERALLY SPONSORED RESEARCH AND DEVELOPMENT

This invention was made with Government support under the following grants:

Grant No. W911NF-09-D-0001, awarded by Army Research Office via the Institute for Collaborative Biotechnologies (ICB), having as its principal investigator Daniel E. Morse;

Grant No. DEFG02-02ER46006, awarded by the U.S. Dept. of Energy under “Biological and Biomimetic Low-Temperature Routes to Materials for Energy Applications”, having as its principal investigator Daniel E. Morse; and

Grant No. DE-SC0001009, awarded by the U.S. Dept. of Energy via the Center for Energy Efficient Materials (CEEM), having as its principal investigator Daniel E. Morse.

The Government has certain rights in this invention.

### BACKGROUND OF THE INVENTION

1. Field of the Invention

The invention is related generally to the field of electronic devices, and more particularly, to high-power nanocomposite cathodes for lithium-ion batteries.

2. Description of the Related Art

(Note: This application references a number of different publications as indicated throughout the specification by one or more reference numbers within brackets, e.g., [Ref. n]. A list of these different publications ordered according to these reference numbers can be found below in the section entitled “References.” Each of these publications is incorporated by reference herein.)

Rechargeable batteries have become commonplace in use, especially in consumer electronics devices such as cellular telephones, toys, and other portable electronics devices. Typically, these rechargeable batteries use lithium-ion (Li-ion) devices as rechargeable components to supply power. Li-ion battery technology, however, are expensive and time-consuming to fabricate and have limitations in terms of performance even with the expensive and lengthy production techniques of the related art.

FIGS. 1A and 1B are illustrations of the charge (FIG. 1A) and discharge (FIG. 1A) processes in a lithium-ion (Li-ion) battery of the related art.

System 100 illustrates a rechargeable battery 102, e.g., a Li-ion battery, being charged by a charger 104. Anode 106 and cathode 108 are immersed in an electrolyte 110, and separator 111 maintains electropotential differences between anode 106 and cathode 108. As charger 104 provides an electropotential difference across anode 106 and cathode 108, current 112 (flowing opposite that of electrons 114) forces ions 116 to move from cathode 108 to migrate from cathode 108 to anode 106, thus increasing the voltage potential between cathode 108 and anode 106.

In FIG. 1B, once the Li-ions 116 have been moved from cathode 108 to anode 106, a load 120 is applied between cathode 108 and anode 106. Current 112 (flowing opposite to the electrons 114) now flows through load 118 and to anode 106, which forces Li-ions 116 back to cathode 108. Once the potential difference between cathode 108 and anode 106 is small enough, there is not enough energy to force significant amounts of electrons 114 from anode 106 to cathode 108, i.e., there is not enough energy to move enough Li-ions 116 from anode 106 to cathode 108, and the battery 102 must be recharged as in FIG. 1A.

As the ions 116 move from one electrode to the other as a result of moving the electrons 114 through an external circuit—a negatively charged electrode (anode 106 in FIG. 1A, and cathode 108 in FIG. 1B) will attract positively charged ions 116 that are free to move through electrolyte 110 and separator 111. To provide efficient and effective charging of battery 102, anode 106 and cathode 108 (the electrodes) should be of high electronic conductivity to allow for efficient transfer of electrons 114 and ions 116 through electrolyte 110. Otherwise, if the conductivity of anode 106 and/or cathode 108 is low, there is additional electrical resistance in battery 102, which does not allow for full charge or discharge of the system 100. [Ref. i]

Cathode 108 materials for lithium-ion batteries typically suffer from poor electronic conductivity, which has a deleterious consequence for their charge and discharge capabilities—the cathodes 108 in Li-ion batteries 102 of the related art typically require the addition of an electronically conductive material to allow for better ion 116/electron 114 flow through electrolyte 110 and separator 111.

In the related art, the electronic conductivity of cathodes 108 had been improved primarily through post-synthesis modification. Generally, the electrochemically active material of the cathode 108 (usually in the form of a crystalline powder) was mixed with carbon black or some other conductive additive after being synthesized. [Refs. iii, iv, v, vi, vii, viii, ix]

The related-art approach, however, has found extreme difficulty in achieving a homogeneous mixture at the nano-scale by such post-synthesis mixing. Such homogeneity is needed to provide, among other things, large numbers of charge/discharge cycling such that the Li-ions 116 have a large number of satisfactory sites to engage on cathode 108. Related art methods typically required mechanical mixing times exceeding several hours or even days. Moreover, this mechanical mixing may degrade the crystal structure of the electrochemically active materials, rendering cathode 108 less than desirable in terms of electrical conductivity.

An example of the normal fabrication procedure of the related art of a working cathode material for lithium-ion batteries involves four general steps [Ref. ix]:
1. Preparation of a precursor. This can be ball-milling of chemically pure salts such as LiOH and Mn(CH₃COO)₂ or aqueous mixing of water soluble salts followed by evaporation of the water. Most methods produce a powdered precursor.
2. The precursor is then calcined in a muffle furnace in an oxygen atmosphere to induce a phase transition and thermal decomposition of the salt counter ions (acetates, hydroxides). Usually, the temperature necessary to produce an adequate crystallinity of the electrochemically active material lies in the range between 700° C. and 900° C.
3. The third step is a grinding step wherein the particle size of the calcined powder is reduced.
4. The fourth and last step is then mixing of this electrochemically active material with conductive additives by grinding, ball-milling, dispersing and filtrating or various other methods. An example of the recommended mixing steps for a state of the art commercially available conductive additive such as BTY-175 (Blue Nano [Ref. ii]) and the electrochemically active material follows below. Here the mixing is performed in the organic solvent N-methyl-2-pyrrolidone (NMP), with the polymer PVDF (polyvinylidene fluoride) as binder:
   A) Dry BTY-175 in an oven at 80° C. for 2-3 hours;
   B) Add the dried BTY-175 to NMP oil to 5 wt % concentration;
   C) Stir the high-viscosity mixture at speed (>2000 rpm) for two hours until it becomes an evenly dispersed conductive slurry;
   D) Add a PVDF solution to the conductive slurry;
   E) Continue stirring the mixture at high speed (>2000 rpm) for one hour;
   F) Add the electro-active material;
   G) Stir the mixture at 1500 rpm for 4 hours;
   H) Stir at 500 rpm for 30 min (or 1.5 hour for cathode use).

The above list of eight mixing steps (from A-H) is an example of the cumbersome methodology typically required to increase the electronic conductivity of cathodes for lithium ion batteries.

FIG. 2 is a schematic illustration of the post-synthesis mechanical mixing of electrochemically active particles of the related art.

Process 200 illustrates that a combination 202 of electrochemically active particles 204, which are typically spheroids, with a conductive matrix 206, e.g., carbon nanotubes, typically results in structure 208, where active particles are attached to matrix 206 but not well dispersed and not dispersed in a homogeneous fashion. Consequently, the electrochemically active material 204 is not uniformly distributed within the conductive matrix 206 of the carbon nanotubes in structure 208. Instead, large segregated domains of the two materials 204 and 206 are typically produced, and these segregated domains reduce the electrochemical performance of the resulting cathode 108, especially reducing its cyclability and power, because the Li-ions 106 cannot attach to the matrix 206 portions of structure 208, and the amorphous portions of particles 204 in structure 208 cannot accept a large density of ions 116 for charging/discharging purposes.

Additionally, such post-synthesis mechanical mixing often introduces unwanted impurities as well as the destruction of specifically required morphology or nanostructure of one or more of the components 204 and 206 in structure 208.

Thus, there is a need in the art for improved methods for manufacturing electronically conductive electrode (anode, cathode) materials or composites for lithium-ion batteries.

### SUMMARY OF THE INVENTION

To overcome the limitations in the prior art described above, and to overcome other limitations that will become apparent upon reading and understanding the present specification, the present invention discloses high-power nanocomposite cathodes for lithium-ion batteries and methods for fabricating the same. The term “high-power” relates to the ability of an electrochemical cell (e.g., a battery) to charge and/or discharge the stored energy rapidly (e.g., within minutes instead of hours). This is very important for the feasibility of certain devices, e.g., electric vehicles, and other applications of electrical energy.

Specifically, the present invention discloses a method of growing electrochemically active materials in situ within a dispersed conductive matrix to yield nanocomposite cathodes or anodes for electrochemical devices, such as lithium-ion batteries.

The growing step comprises an in situ i.e., in the reaction mixture, formation of a precursor of the electrochemically active materials within the dispersed conductive matrix followed by a chemical reaction to subsequently produce the nanocomposite cathodes or anodes, wherein: the electrochemically active materials comprise nanocrystalline electrochemically active metal oxides, metal phosphates or other electrochemically active materials; the dispersed conductive matrix forms an interconnected percolation network of electrically conductive filaments or particles, such as carbon nanotubes; and the nanocomposite cathodes or anodes comprise a homogeneous distribution of the electrochemically active materials within the dispersed conductive matrix.

A method of introducing electrochemical materials in situ in accordance with one or more embodiments of the present invention comprises dispersing a conductive matrix, permeating the dispersed conductive matrix with a precursor material, locking the conductive matrix in a dispersed state, and treating the locked conductive matrix to disperse an electrochemically active material in the locked conductive matrix.

Such a method further optionally comprises the precursor material being used to synthesize the electrochemically active material, transforming the precursor material into the electrochemically active material, the electrochemically active material being dispersed in a uniform manner in the locked conductive matrix, the conductive matrix being a material selected from a group comprising: carbon nanotubes, can also comprise one or more of Multi-Walled Carbon Nanotubes (MWCNTS), Double-Walled Carbon Nanotubes (DWCNTs), Single-Walled Carbon Nanotubes (SWCNTs), Carbon Black, Acetylene Black, Super P, Carbon nanofibers, Graphene, and Graphite, the electrochemically active material being a material selected from a group comprising LiMn₂O₄, LiNiₓMn₂₋ₓO₄, LiFePO₄, LiMnPO₄, LiCoPO₄, LiNiₓCo_{y}Al_{z}O₂, LiCoO₂, LiMnₓCo_{y}Ni_{z}O₂, and Li₄Ti₅O₁₂, the conductive matrix being dispersed using sonication, filtering the treated locked conductive matrix, drying the filtered, treated, locked conductive matrix, the electrochemically active material comprising one or more of a nanocrystalline electrochemically active metal oxide, a microcrystalline electrochemically active metal oxide, and a metal phosphate, and the treated locked conductive matrix comprising a cathode of an electrochemical cell.

A cathode for an electrochemical device in accordance with one or more embodiments of the present invention comprises a conductive matrix, and an electrochemically active material, coupled to the conductive matrix, wherein a precursor locks the conductive matrix in a dispersed state such that the electrochemically active material is distributed in the dispersed conductive matrix.

Such an electrochemical device further optionally comprises a lithium-ion battery.

Such a cathode further optionally comprises the conductive matrix being a material selected from a group comprising: carbon nanotubes, can also comprise one or more of Multi-Walled Carbon Nanotubes (MWCNTS), Double-Walled Carbon Nanotubes (DWCNTs), Single-Walled Carbon Nanotubes (SWCNTs), Carbon Black, Acetylene Black, Super P, Carbon nanofibers, Graphene, and Graphite, the electrochemically active material being a material selected from a group comprising LiMn₂O₄, LiNiₓMn₂₋ₓO₄, LiFePO₄, LiMnPO₄, LiCoPO₄, LiNiₓCo_{y}Al_{z}O₂, LiCoO₂, LiMnₓCo_{y}Ni_{z}O₂, and Li₄Ti₅O₁₂, the electrochemically active material being homogeneously distributed within the dispersed conductive matrix, the precursor being used to synthesize the electrochemically active material, and the precursor being transformed into the electrochemically active material.

### BRIEF DESCRIPTION OF THE DRAWINGS

Referring now to the drawings in which like reference numbers represent corresponding parts throughout:

FIGS. 1A and 1B are illustrations of the charge (FIG. 1A) and discharge (FIG. 1A) processes in a lithium-ion (Li-ion) battery of the related art.

FIG. 2 is a schematic illustration of the post-synthesis mechanical mixing of electrochemically active particles of the related art.

FIGS. 3A and 3B illustrate processes associated with one or more embodiments of the present invention.

FIG. 4 is a graph of X-ray diffraction patterns of the crystalline precursor Li/Na—MnO₂, the final LiMn₂O₄ product, and a reference standard of pure LiMn₂O₄.

FIGS. 5A and 5B are scanning electron micrographs (SEMs) of the highly agglomerated MWCNTs (FIG. 5A) and the synthesized layered Na/Li—MnO₂ precursor within the highly dispersed MWCNTs (FIG. 5B).

FIGS. 6A-6D are scanning electron micrographs (SEMs) at different magnifications, including 10000× (FIG. 6A), 25000× (FIGS. 6B and 6C) and 150000× (FIG. 6D) of the final nanocrystalline LiMn₂O₄ spinel product consisting of 100-500 nm octahedral shaped crystals and smaller 10-30 nm square crystallites with the MW-CNTs dispersed and embedded in the larger crystals.

FIGS. 7A-7C are transmission electron microscope (TEM) images illustrating the intimate mixing of the MW-CNTs and the crystallinity of the smaller 10-30 nm LiMn₂O₄ spinel nanocrystals.

FIG. 8 is a graph of the rate capability of the LiMn₂O₄-MWCNT nanocomposite produced by one or more embodiments of the present invention.

FIGS. 9A and 9B are graphs providing comparisons to previous related art materials.

FIG. 10 illustrates four examples of the incorporation of MW-CNTs in the electrochemically active particles.

FIG. 11 shows the electrochemical analysis of the in situ mixed LiMn2O4/MW-CNT composite made in accordance with one or more embodiments of the present invention.

FIG. 12 illustrates a process chart in accordance with one or more embodiments of the present invention.

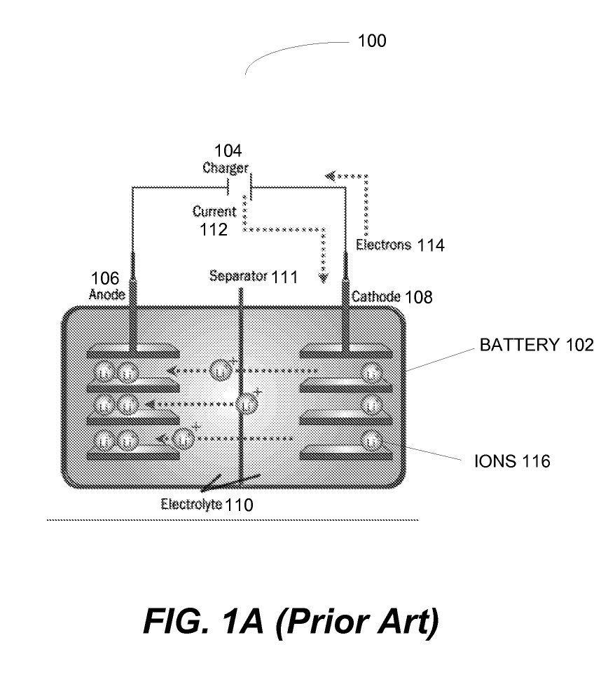

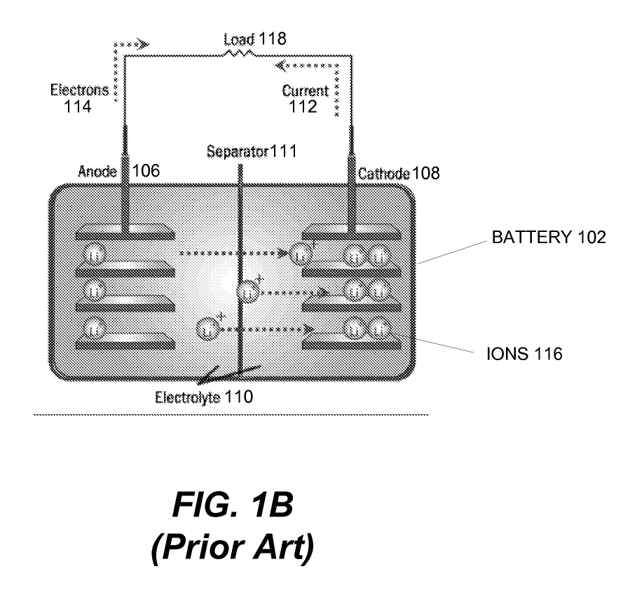

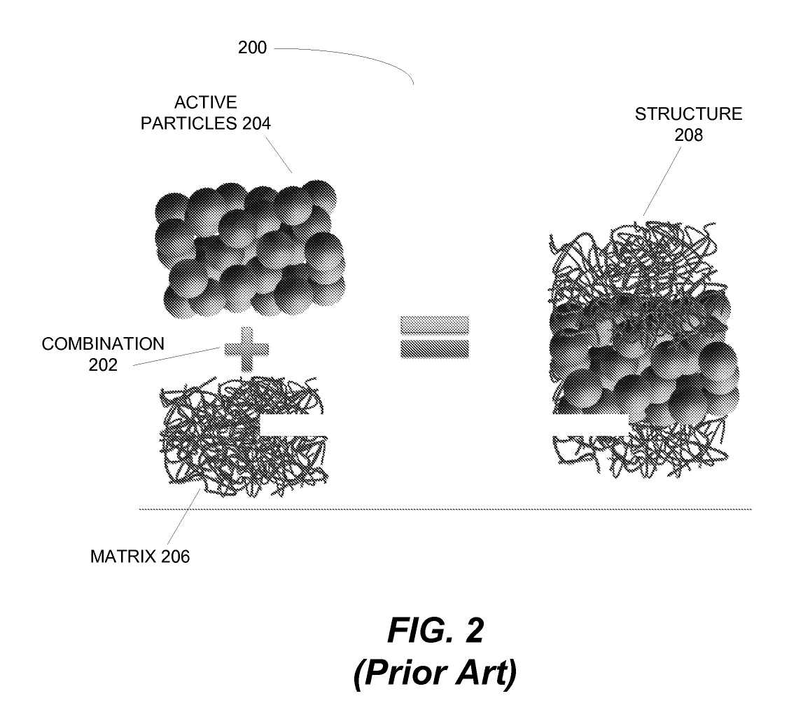

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

The present invention comprises methods for growing nanocrystalline electrochemically active metal oxides, metal phosphates or other electrochemically active materials in situ, within a dispersed and highly conductive matrix, such as carbon nanotubes, and further comprises high-power nanocomposite cathodes or anodes for electrochemical power storage devices. Typically, electrochemical devices in accordance with one or more embodiments of the present invention comprise lithium ion batteries, but other devices are contemplated within the scope of the present invention.

In an embodiment in accordance with the present invention as described herein, a high power cathode comprising nanocrystalline metal oxide homogeneously dispersed by growth in situ within the compliant and conductive matrix of multiwall carbon nanotubes is made by a process in accordance with one or more embodiments of the present invention; such nanocomposite cathodes exhibit exceptionally high electrochemical capacity (i.e., high energy-density), high power-density, high stability and high cyclability.

Methods and apparatuses in accordance with the present invention are different from those described in P.C.T. International Patent Application Serial No. US2010/025944. However, methods and apparatuses in accordance with one or more embodiments of the present invention are envisioned to be used in conjunction with the anodes made by the method described in P.C.T. International Patent Application Serial No. US2010/025944 to yield exceptionally high-power electrochemical storage devices, such as lithium ion batteries.

The present invention comprises in situ formation of a precursor of an electrochemically active material within a highly dispersed and highly conductive matrix followed by chemical reaction to subsequently produce a nanocomposite for use as an electrode (either an anode or a cathode) in electrochemical cells such as, but not confined to, lithium ion batteries.

The conductive matrix in one or more embodiments of the present invention typically forms an interconnected percolation network of electrically conductive filaments or particles. The precursor for the electrochemically active material is typically chosen to yield electrochemically active nanocrystals of high crystallinity, high purity and desired electrochemical activity within the conductive matrix. The highly conductive additive is typically dispersed in the precursor solution, and the homogeneous starting mixture of the precursor provides the basis for subsequent in-situ conversion, by hydrothermal treatment or other chemical reaction, of the precursor to the final electrochemically active nanocrystals uniformly distributed within the highly conductive matrix.

One or more embodiments of the present invention thus results in a nanocomposite material, exhibiting a homogeneous distribution of the electrochemically active nanocrystallites within the highly conductive matrix, with advantages for electrochemical operations. In one example, the high-power cathode for lithium ion batteries made by this method exhibits exceptionally high electrochemical capacity (high energy density), high power density, high stability and high cyclability.

One or more embodiments of the present invention have produced working prototypes of a high-power cathode for lithium ion batteries. Specifically, one or more embodiments of the present invention have already shown advantages over the related art methods and apparatuses.

The methods and apparatuses of the present invention exhibit very high-power devices, with capacity retention of 96% after discharge at 10 C, 80% retention after discharge at a higher rate of 20 C, and full recovery to 100% of original capacity after exhaustive discharge at 50 C. The methods and apparatuses of the present invention also exhibit high energy-density and high stability and cyclability, and a relatively high voltage (average voltage of 4.0V vs. Li/Li+). The present invention also reduces material costs (reagents include NaOH, LiOH, KMnO4 and acetone—all very common chemicals—and industrially produced carbon nanotubes available at prices lower than that of graphite) as compared to the related art, reduces the complexity of the manufacturing method to a facile five-step one-pot synthesis involving chemie douche heating up to a maximum temperature of 180° C., and minimizes toxic waste associated with production as compared to the related art.

Further, methods in accordance with the present invention are generic with respect to materials, and should prove equally useful for the synthesis of other carbon nanotube composites with LiFePO₄, LiCoO₂ or LiNi_{0.5}Mn_{1.5}O₄, as well as various anodes.

General Description

The present invention comprises one or more processes comprising a synthesis of an electrochemically active material uniformly dispersed within an in situ conductive matrix.

Typically, the present invention forms a chemical precursor of an electrochemically active material within the highly dispersed in situ conductive matrix, and then converts the precursor to the final, nanocrystalline electrochemically active material. Apparatuses made in such a fashion in accordance with one or more embodiments of the present invention comprise a composite exhibiting a homogeneous mixture of the nanocrystalline electrochemically active material uniformly distributed within the conductive matrix.

The properties of the resulting nanocomposite materials in accordance with one or more embodiments of the present invention, in the case of the particular example described below, are those of a unique high-power cathode for lithium ion batteries, with exceptional stability, cyclability, electrochemical capacity (energy-density) and power-density.

Related art attempts at synthesis of electrochemically active particles with conductive additives are typically done after the matrix is made, and are typically hydrothermal synthesis followed by mechanical ball milling of the synthesized mixture with acetylene black (AB) and MWCNTs. Such attempts show that the rate-capability of the end products increase with the addition of conductive additives. However, optimal results of such related art shows a capacity retention of ˜60% at 5 C and 47% at 10 C, whereas embodiments in accordance with one or more embodiments of the present invention attain capacity retention of 99% at 5 C and 97% at 10 C.

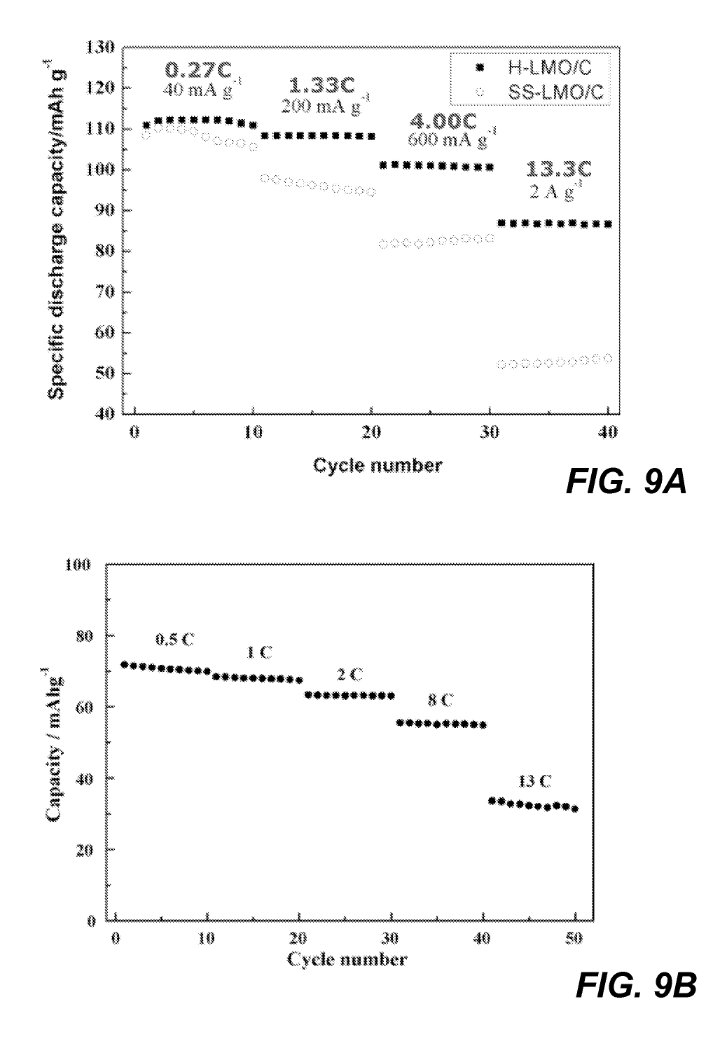

Related art attempts to synthesize electrochemically active particles in situ have been attempted, e.g., synthesis of an in-situ mixture of acetylene black (as a conductive additive) and MnO₂ as a precursor for the hydrothermal conversion into LiMn₂O₄. [x]FIGS. 9A and 9B show the result of such related art attempts. For comparison, FIGS. 9A and 9B illustrate a capacity retention of ˜88% at 5 C and ˜78% at 10 C, whereas embodiments in accordance with one or more embodiments of the present invention attain capacity retention of 99% at 5 C and 97% at 10 C.

The related art [xi] has also attempted to produce a composite through an in-situ mixing of MWCNTs in a sol-gel synthesis. The precursor is calcined at 250° C. for 30 hours in order to form the electrochemically active material without decomposing the MWCNTs, resulting in a weak crystallinity that is manifest in the low initial capacity around 70 mAh/g. The rate capability shows around 80% capacity retention at 8 C and around 40% capacity retention at 13 C of this related art compares rather poorly with one or more embodiments of the present invention having capacity retention of 99% at 5 C and 97% at 10 C.

Another related art approach [xii] involves in-situ mixing of MWCNTs in a KMnO₄ solution without a dispersion step and then hydrothermal production of a MnO₂/MWCNT composite. This composite shows high capacity but a low non-uniform voltage plateau ranging from 2.8V to 2.2V, compared to 4V of one or more embodiments of the present invention.

In summary, this invention is a new process based on an in-situ (or pre-synthesis as opposed to post-synthesis) growth of an electrochemically active material within a highly dispersed and highly conductive matrix comprising Multi-Walled Carbon Nanotubes (MWCNTS), Double-Walled Carbon Nanotubes (DWCNTs), Single-Walled Carbon Nanotubes (SWCNTs), Carbon Black, Acetylene Black, Super P, Carbon nanofibers, Graphene, Graphite, or other matrices in accordance with the present invention.

The nanocrystalline electrochemically active material product grown within the conductive matrix may comprise LiMn₂O₄, LiNiₓMn₂₋ₓO₄, LiFePO₄, LiMnPO₄, LiCoPO₄, LiNiₓCo_{y}Al_{z}O₂, LiCoO₂, LiMnₓCo_{y}Ni_{z}O₂, Li₄Ti₅O₁₂, and other materials compatible with the in-situ growth methods in accordance with the present invention.

The chemical conversion to the nanocrystalline electrochemically active material uniformly dispersed within the highly conductive matrix results in significant improvement of performance of electrochemical cells comprising lithium-ion primary batteries, lithium-ion secondary batteries, supercapacitors, sodium-ion batteries, lithium-air batteries, and other electrochemical cells.

### Process Description

A process in accordance with one or more embodiments of the present invention produces a composite material. Typically, this is done in a single container (one-pot) synthesis. One method in accordance with one or more embodiments of the present invention is as follows.

The conductive matrix is first typically dispersed using ultra-sonication and a dispersing agent. Sufficient dispersion typically requires a high-power sonication (sound-generating) device that can exert significantly more power than a normal ultrasonic bath. The dispersion agent is comprised of any of a number of ions, molecules or compounds that aid in the stable dispersion of the specific conductive matrix to be employed (e.g., carbon nanotubes). In some cases, as in the example illustrated below, the dispersion agent may also be necessary for the synthesis of the electrochemically active materials.

A rapid chemical reaction is then induced that forms a solid or gel of an inorganic precursor of the electroactive materials within, around and among the dispersed elements of the conductive matrix. The resulting precursor engulfs or incorporates some elements of the conductive matrix, locking them in the dispersed state. This second step can comprise any form of chemical reaction that is needed to precipitate the precursor from dissolved species, e.g., heating, cooling, addition of a reducing or oxidizing agent, addition of a catalyst, mechanical stirring or shaking, irradiation with light, microwave or other radiation, etc.

The third step is a hydrothermal or solvo-thermal process that involves heating the precursor of the electrochemically active materials and the associated conductive matrix in a sealed pressure vessel (e.g., a Parr Bomb, autoclave, or other pressure vessel apparatus) to an elevated temperature, which transforms the inorganic precursor into the final nanocrystalline electrochemically active materials, uniformly dispersed in the conductive matrix. Formation of this nano-composite typically requires temperatures between 120° C. and 240° C.

The final nano-composite is then typically cooled to room temperature and filtered for collection. A filter with an appropriate pore size to collect the composite is used.

The composite is then dried in an oven at elevated temperatures (typically around 80° C.).

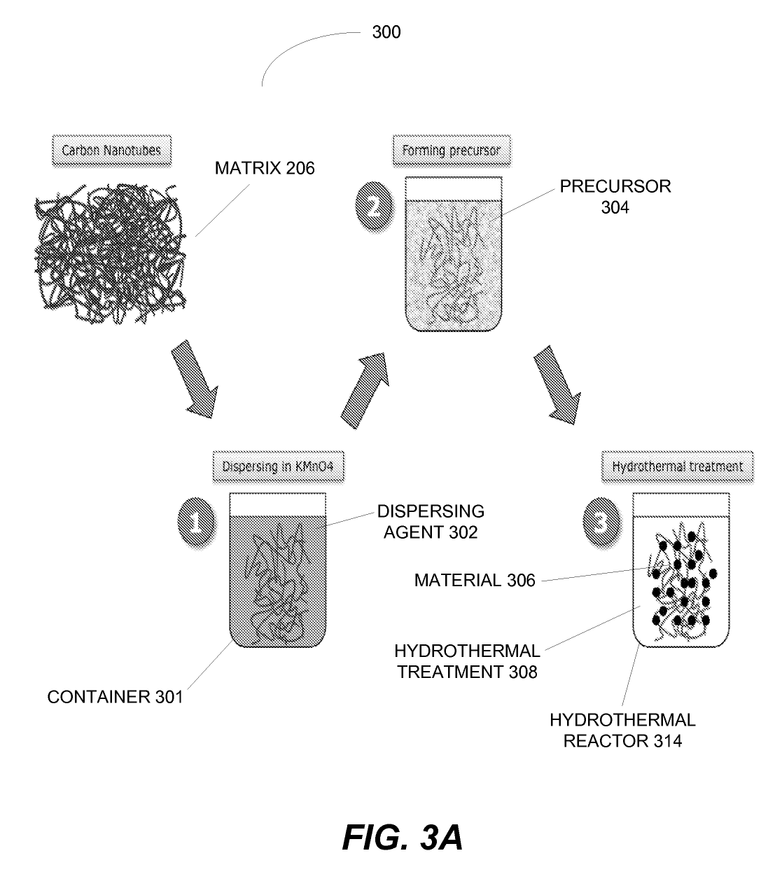

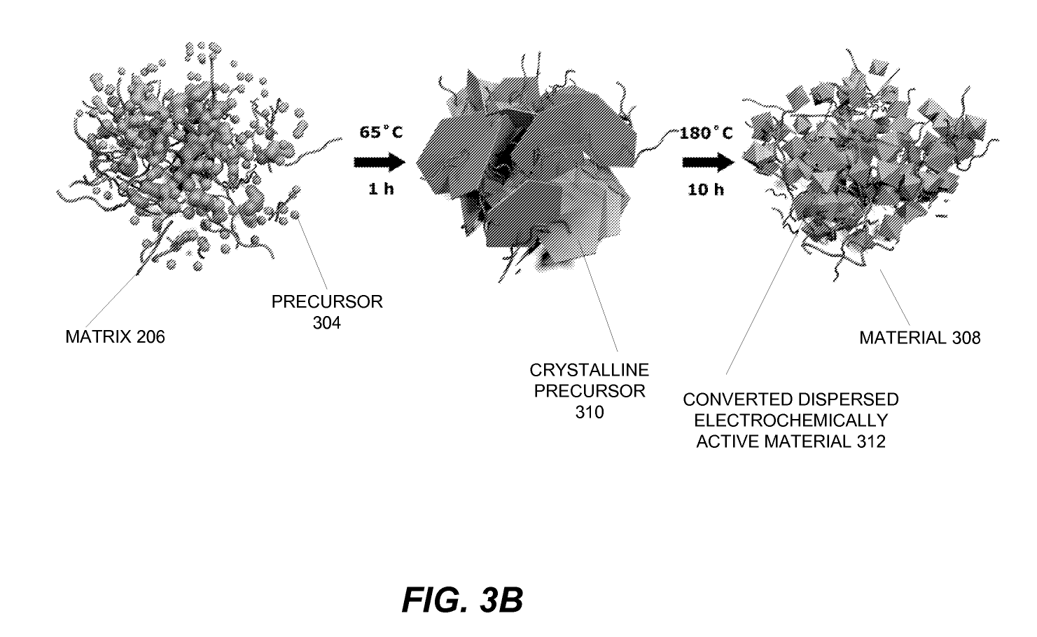

FIGS. 3A and 3B are illustrations of some of the processes used in one or more embodiments of the present invention.

As shown in process 300, matrix 206, shown in FIG. 3A as carbon nanotubes, is placed in a container 301, typically a beaker, and dispersed in a dispersing agent 302. Other matrix 206 materials can be used without departing from the scope of the present invention. Dispersing agent 302 is typically KMnO₄, but can be other materials or liquids without departing from the scope of the present invention.

Dispersion can take place through several methods, e.g., heating, sonic wave application, or, if desired, through extended time of contact between matrix 206 and dispersing agent 302. Depending on the matrix 206 material and dispersing agent 302 chosen or desired, one or more methods of dispersion may be required or employed without departing from the scope of the present invention.

A precursor 304 is then formed in the dispersing agent 302 by adding a reagent or reaction-inducing material, typically acetone but can be other materials, solids, or liquids, without departing from the scope of the present invention. Other precursor formation methods, such as heat or additional heating of dispersing agent 302 in the presence of matrix 206, exposure of the dispersing agent 302/matrix 206 solution to light, or other chemical reaction-inducing methods, can be used without departing from the scope of the present invention. Further, the dispersing agent 302 can aide in forming the precursor on matrix 206, or can merely prepare matrix 206 for the precursor 304, depending on the materials used and the processes employed in accordance with the present invention. In the present example process 300, the dispersing agent 302 does aide in the chemical formation of the precursor 304 to the electrochemically active material 306 deposited in the matrix 206. Once electrochemically active material 306 is deposited in matrix 206 to a desired degree, hydrothermal treatment 308 of material 306 is typically undertaken to stabilize material 306.

The final product, i.e., material 306, can be used directly as a cathode 108 or other electrode in a device. The present invention, although filtering and/or drying of the material 306 may be required after hydrothermal treatment 308, does not require any grinding or other post-synthesis processing for use as an electrode in an electrochemical cell.

In the example provided, the final nanocomposite material 308 is a powder that exhibits a highly increased electronic conductivity compared to the electrochemically active material 206 alone. The increased electronic conductivity enables the material 308 for use in a wider range of electrochemical applications, and offers increased performance as compared to matrix 206 without employing one or more embodiments of the present invention.

FIG. 3B illustrates the phases of the matrix 306 during one or more processes and embodiments of the present invention.

The precursor phase 304 of material 308 is induced at a certain amount of time and at a certain temperature, e.g., 70° C. for 1 hour, a crystalline precursor 310 is formed in matrix 206. Typically, this crystalline precursor 310 is Na/Li—MnO₂, but can be other materials depending on the precursor 304 and the matrix 206 being employed. This crystalline precursor 310 effectively locks the matrix 206 in the highly dispersed state induced by the ultra-sonication. Other temperatures, times, and materials can be used without departing from the scope of the present invention.

In the hydrothermal treatment 308 phase, the crystalline precursor 310 laden matrix 206 is After one hour, the liquid mixture containing the crystalline Na/Li—MnO₂ is manipulated to form the electrochemically active material 312 dispersed within the matrix 206. Typically, this is performed by adding water to the precursor 304 solution and transferring this mixture into a hydrothermal reactor 314, and adding heat, then allowing the material 308 to cool to room temperature. If necessary, the material 308 is then filtered from the solution and/or dried such that the material 308 is useable in devices or applications. Typically, this is done by adding 250 mL of pure (Milli-Q) water and pouring the precursor solution 304 with the crystalline precursor 310 material into a 1 L Teflon-lined hydrothermal reactor and heated to 180° C. After 10 hours, the solution is allowed to cool to room temperature, from 180° C. to 30° C. in 3 hours. This hydrothermal reaction quantitatively converts the Na/Li—MnO₂ precursor 310 to highly crystalline LiMn₂O₄ 312, which is uniformly dispersed throughout the MWCNT conductive matrix 206.

Specific Example

As mentioned above, the present invention can be applied to any type of electrochemically active material or its precursor that can be precipitated from a solution. As an example of such a material 308, the present invention is shown as feasible by way of example and illustration as described below, which is shown by way of example and not to be construed as limiting the scope of the present invention.

In accordance with one or more embodiments of the present invention, the material 308 can be, for example, electrochemically active material LiMn₂O₄, which can be uniformly dispersed by in situ synthesis within a conductive matrix 206 comprised of multiwall carbon nanotubes (MW-CNTs).

In accordance with one or more methods of the present invention, the following process description is a specific example of the general processes of the present invention described above.

As described with respect to FIG. 3A, a pre-weighed amount of conductive matrix 206 of MW-CNTs and dispersing agent 302 of KMnO₄ which also acts as a precursor reactant were added to 100 mL water in a 140 mL glass beaker 301.

A high-power ultra-sonication device was used to sonicate beaker 301 containing the matrix 206 immersed in dispersing agent 302. Sonication was performed twice for 15 minutes, with a 5 minute interval in between, which delivered ˜130 kJ at an average of 70 W. Although optional with respect to the present invention, the sonication also served to degas the solution, such that there was negligible O₂ remaining to possibly an impurity, Mn₃O₄ within matrix 206.

The beaker 301 was then transferred to a stirrer and stirred at 700 rpm while adding 150 mL of a degassed (sonicated) alkaline solution of LiOH (in slight excess) and NaOH (mineralizing catalyst) while heating to a temperature of 40° C. The final concentrations in this case are (but not limited to) 60 mM KMnO₄, 32 mM LiOH, 0.2 M NaOH and 5-15 wt. % MWCNTs.

After stirring for one minute, 30 mL of high purity acetone (spectrograde) was added. The solution changed color from dark purple (near black) to dark green and then to light brown. This color change was due to the reduction of the permanganate MnO₄⁻ ion (purple) to the manganate MnO₄²⁻ ion (green) and the subsequent precipitation of MnO₂ (brown). The addition of acetone increased the temperature to 50° C. (the redox reaction is an exothermic process).

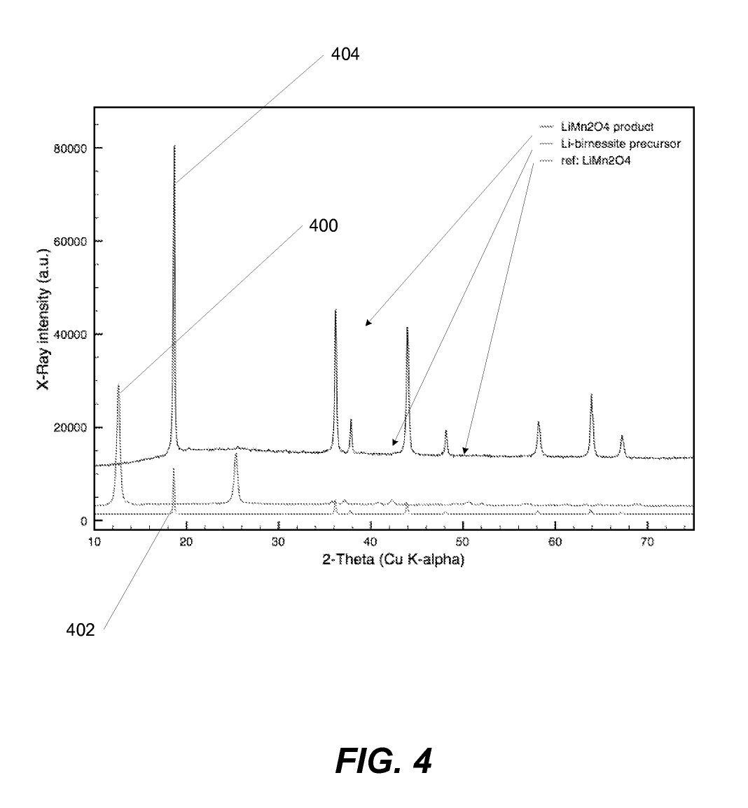

FIGS. 4 to 11 show the typical methods of analysis used to characterize the resulting nanocomposite to be used as a cathode for lithium ion batteries in accordance with one or more embodiments of the present invention.

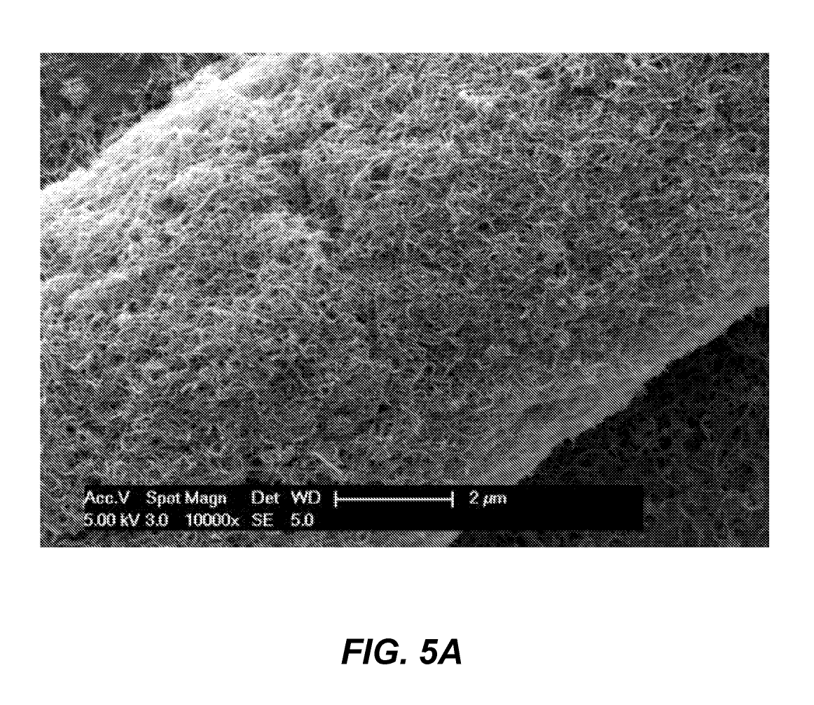

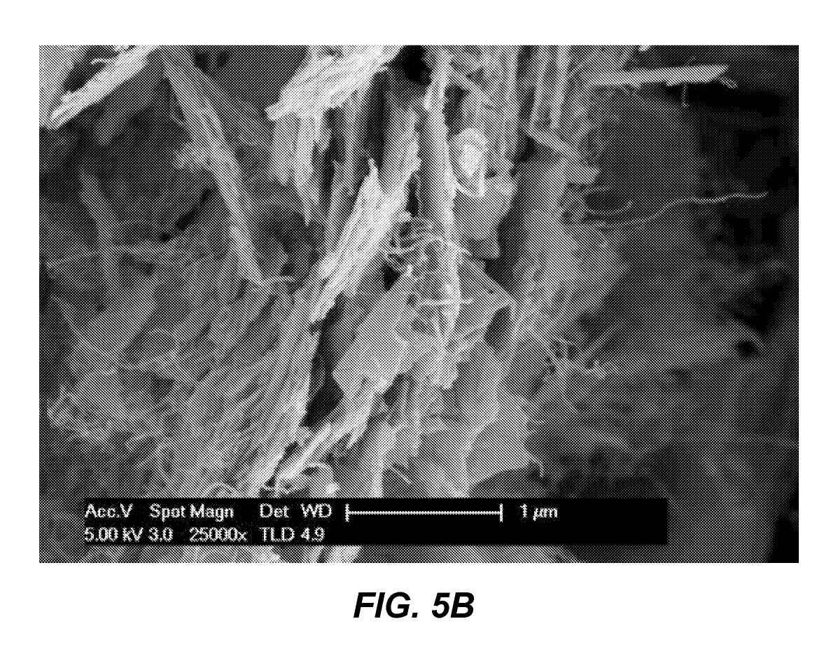

With further heating to 70° C., and maintaining that temperature for 1 hour, a crystalline Na/Li—MnO₂ phase (i.e. crystalline precursor 310) is formed around the MW-CNTs as shown by the x-ray intensity peak 400 in the graph of FIG. 4, effectively locking the matrix 206 in the highly dispersed state induced by the ultra-sonication. Microphotographs of the matrix 206 material in a dispersed state with the crystalline precursor 310 are further shown in FIGS. 5A and 5B.

FIGS. 5A and 5B are scanning electron micrographs (SEMs) of the highly agglomerated MWCNTs (FIG. 5A) and the synthesized layered Na/Li—MnO₂ precursor within the highly dispersed MWCNTs (FIG. 5B).

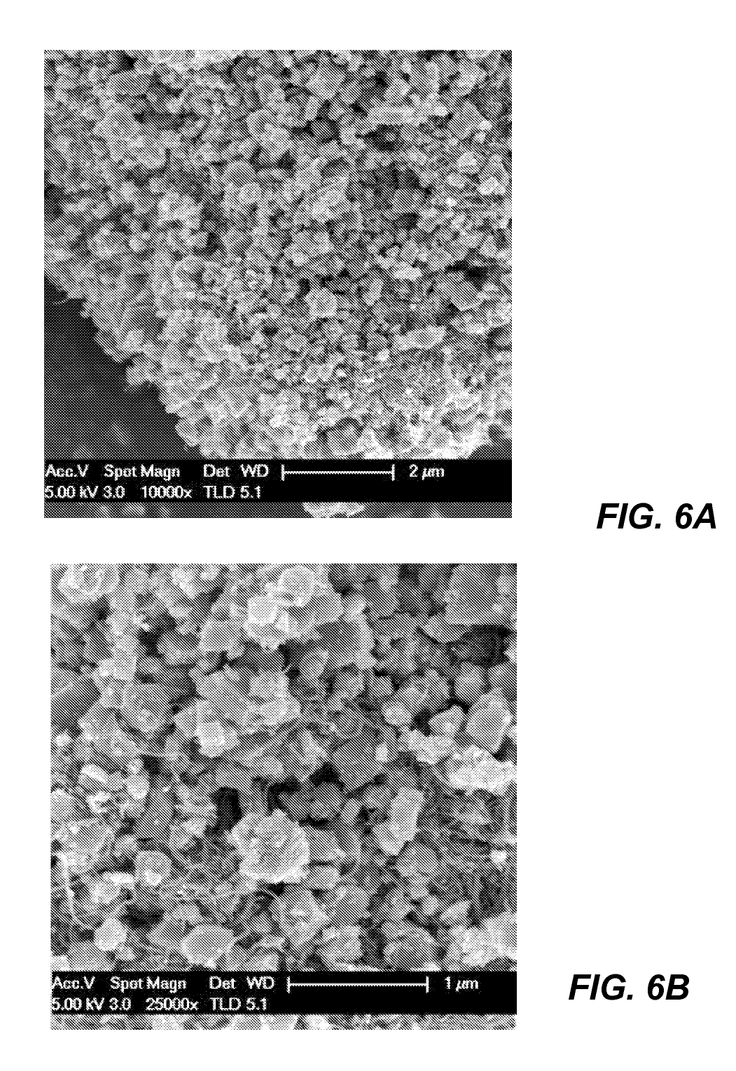

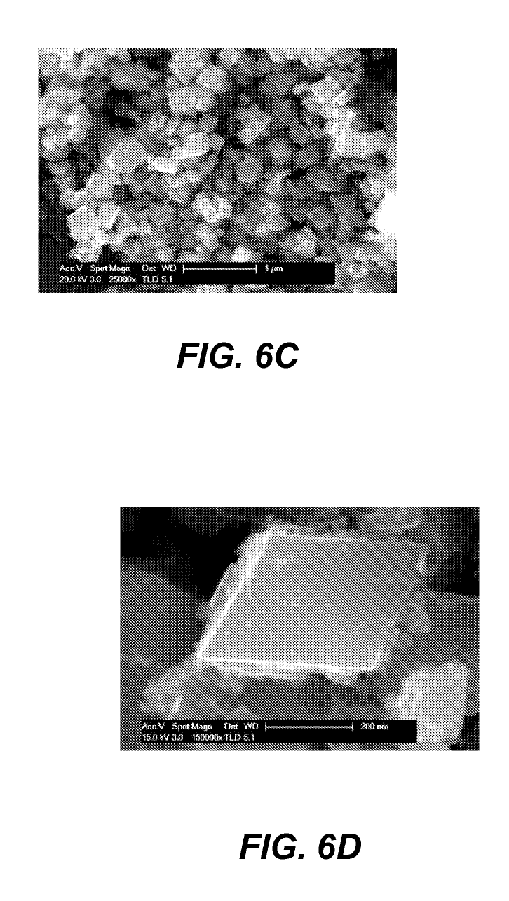

After one hour, the liquid mixture containing the crystalline Na/Li—MnO₂ is adjusted to 250 mL by addition of pure (Milli-Q) water and poured into a 1 L Teflon-lined hydrothermal reactor and heated to 180° C. After 10 hours, the solution is allowed to cool to room temperature (from 180° C. to 30° C. in 3 hours). This hydrothermal reaction is shown to quantitatively convert the Na/Li—MnO₂ precursor to highly crystalline LiMn₂O₄ as shown by peaks 402 (reference peak) and 404 (of a sample produced in accordance with one or more embodiments of the present invention), which is uniformly dispersed throughout the MWCNT conductive matrix 206 as shown in FIGS. 6A-6D, 7A-7C and 10.

FIGS. 6A-6D illustrate photomicrographs of the converted dispersed electrochemically active material 310 in material 308.

FIGS. 6A-6D are scanning electron micrographs (SEMs) at different magnifications, including 10000× (FIG. 6A), 25000× (FIGS. 6B and 6C) and 150000× (FIG. 6D) of the final nanocrystalline LiMn₂O₄ spinel product consisting of 100-500 nm octahedral shaped crystals and smaller 10-30 nm square crystallites with the MW-CNTs dispersed and embedded in the larger crystals.

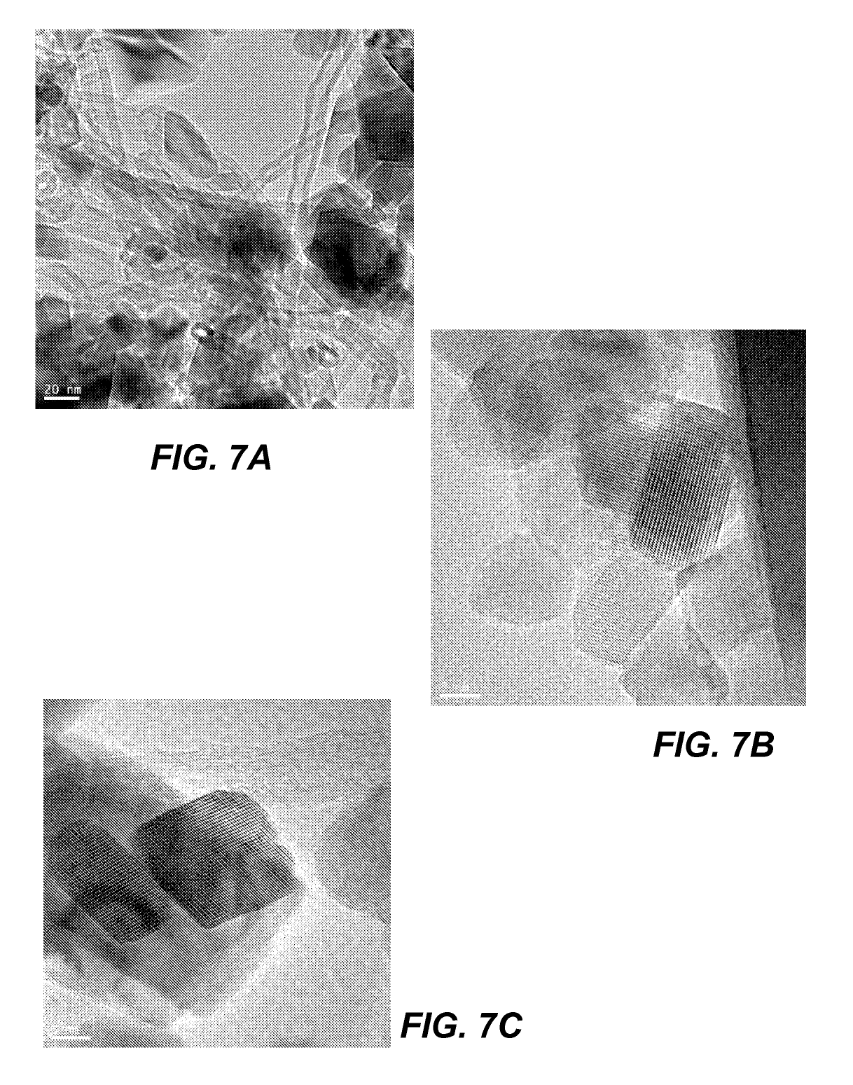

FIGS. 7A-7C are transmission electron microscope (TEM) images illustrating the intimate mixing of the MW-CNTs and the crystallinity of the smaller 10-30 nm LiMn₂O₄ spinel nanocrystals, e.g., the converted dispersed electrochemically active material 310 in material 308.

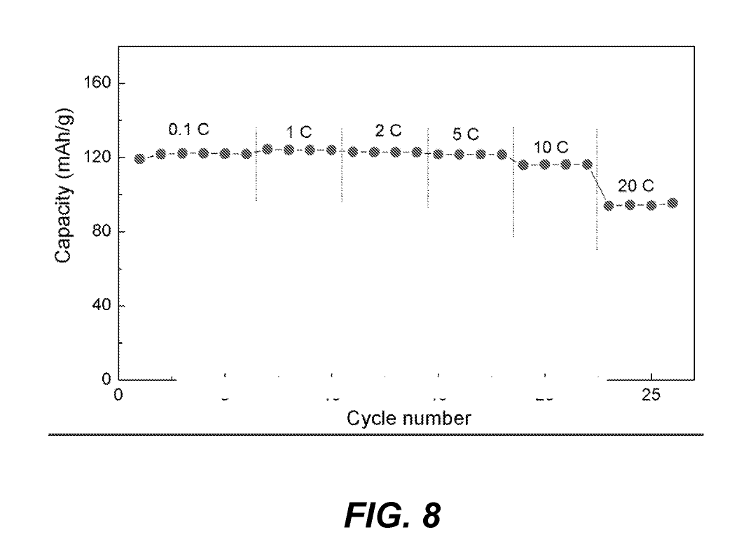

FIG. 8 is a graph of the rate capability of the LiMn₂O₄-MWCNT nanocomposite produced by one or more embodiments of the present invention.

FIG. 8 illustrates the rate capability of a device made in accordance with one or more embodiments of the present invention and used as a cathode for lithium ion batteries. The C-rate (nC) is a measure of the rate of discharge, which is completed in 1/n hours. Thus, 1 C means discharge in 1 hour and 10 C means discharge in 6 minutes. This cathode exhibits excellent rate capability (=“power”), with 96% retention of its original capacity after discharge at 10 C, 80% retention of original capacity after discharge at the very high rate of 20 C, and full recovery to 100% of original capacity after exhaustive discharge at 50 C.

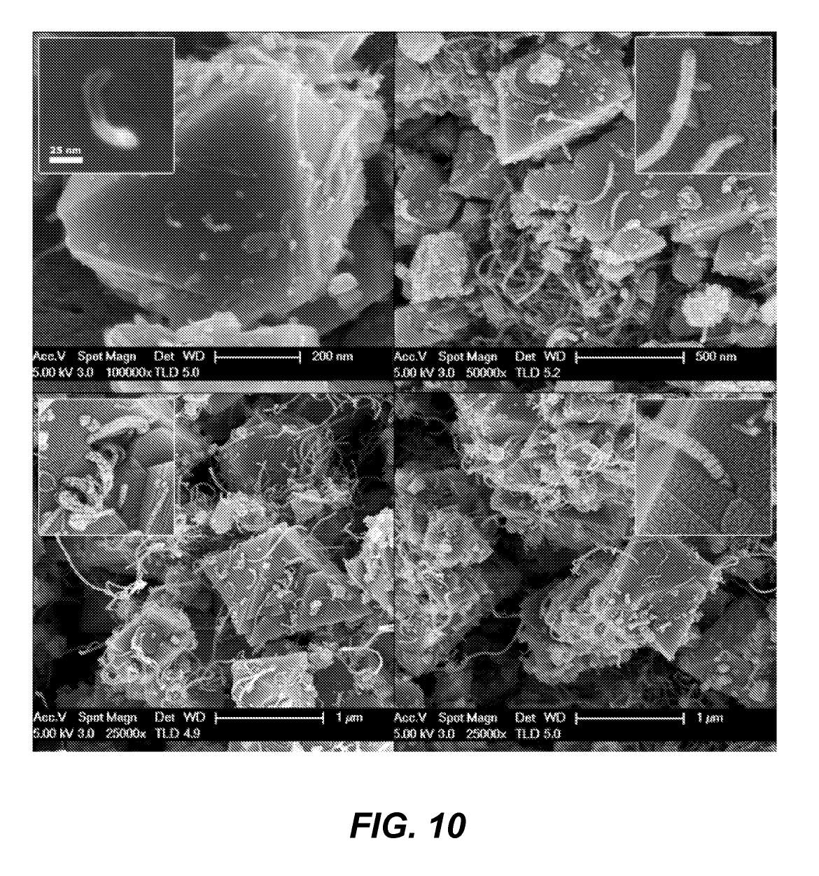

FIG. 10 illustrates additional photomicrographs of the converted dispersed electrochemically active material 310 in material 308.

When cool, the solid nanocomposite product is typically obtained by filtration, e.g., through a 0.45 μm Durapore vacuum filter cup and washed thoroughly with 1.5 L Milli-Q water.

Finally, the clean wet material 308 was dried in an oven at 80° C. for 24 hours, although drying and filtration are optional processes depending on the matrix 206 and material 308 being produced.

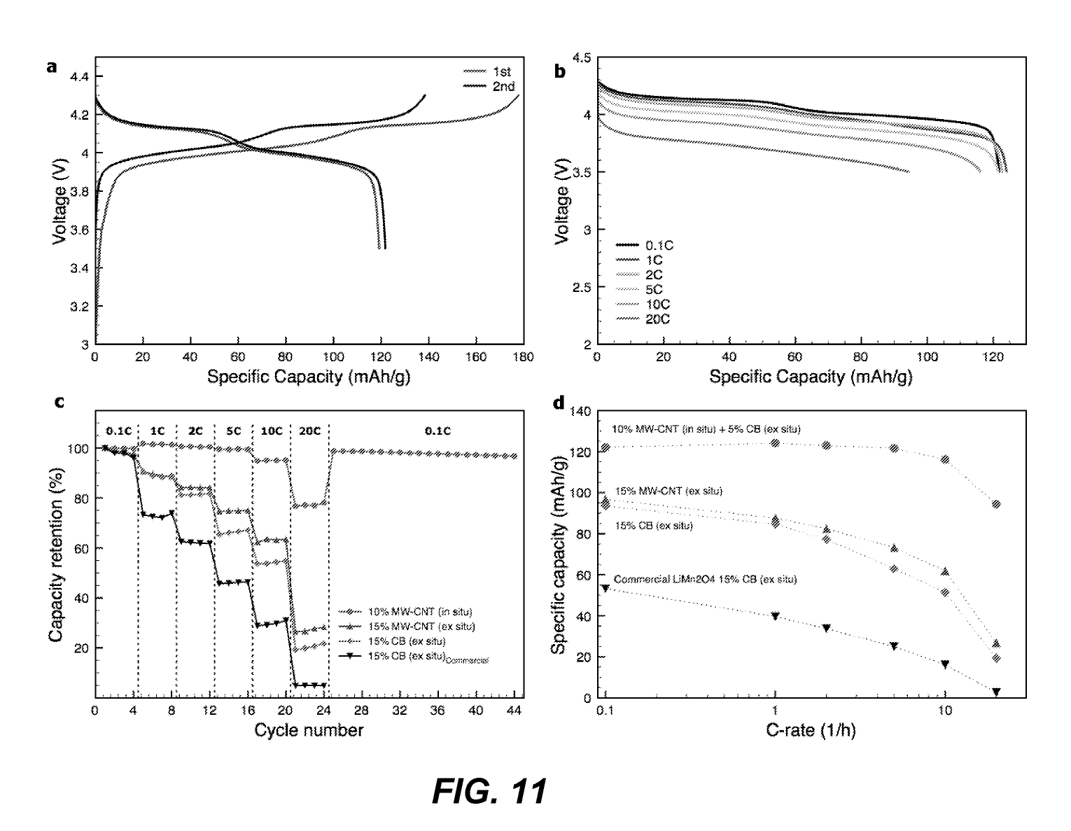

To demonstrate the superior electrochemical performance of the nanocomposite, standard half-cells have been fabricated and tested as shown in FIG. 11. The specific capacity of 116 mAhg⁻¹ at 10 C is superior to the discharge capacities obtained with most other state of the art electrode composites. The electrochemical tests from ex situ mixing composites have also been compared in FIG. 11, showing the high quality of the nanocomposite with highly optimized electronic conductivity caused by the in situ incorporation of the MW-CNTs, a hybrid design that is impossible to obtain with ex situ mixing.

FIG. 11 Graph A shows the first and second charge-discharge voltage profiles at 0.1 C rate for the in situ mixed composite material of the present invention with 10 wt % MW-CNT and 5 wt % CB. Graph B shows the discharge profiles of the composite at various current densities corresponding to the rates from 1 C to 20 C (charge rate was 0.1 C); Graph C shows the comparison of capacity retention (normalized using the specific capacity at the first cycle under 0.1 C) plotted with increasing cycles and C-rates for the four composites tested; and graph d shows the comparison of specific capacity as a function of C-rate of the different composites.

### Possible Modifications and Variations

It is envisioned that the embodiments of the present invention could be utilized and/or optimized through changing one or more of the process parameters of the present invention. Such changes comprise, but are not limited to, increasing the sonication time, increasing the concentration of the dispersion agent, tuning the morphology by changing the hydrothermal conditions of temperature, time, cooling speed, and/or mineralizing catalyst (such as NaOH, KOH) concentration, tuning the precursor with different mineralizing catalysts, and/or using different molecular precursors. Any one or combination of these or other changes to the process parameters are envisioned as being within the scope of the present invention.

The matrix 206, although discussed herein with respect to carbon nanotubes, can also comprise one or more of Multi-Walled Carbon Nanotubes (MWCNTS), Double-Walled Carbon Nanotubes (DWCNTs), Single-Walled Carbon Nanotubes (SWCNTs), Carbon Black, Acetylene Black, Super P, Carbon nanofibers, Graphene, Graphite, or other matrices in accordance with one or more embodiments of the present invention.

The nanocrystalline electrochemically active material 308 product grown or dispersed within the conductive matrix 206 may comprise LiMn₂O₄, LiNiₓMn₂₋ₓO₄, LiFePO₄, LiMnPO₄, LiCoPO₄, LiNiₓCo_{y}Al_{z}O₂, LiCoO₂, LiMnₓCo_{y}Ni_{z}O₂, Li₄Ti₅O₁₂, and other materials compatible with the in-situ growth methods in accordance with one or more embodiments of the present invention. Further, the material 308 can comprise one or more of a nanocrystalline electrochemically active metal oxide, a microcrystalline electrochemically active metal oxide, and a metal phosphate.

The chemical conversion to the nanocrystalline electrochemically active material uniformly dispersed within the highly conductive matrix of the present invention results in significant improvement of performance of electrochemical cells comprising lithium-ion primary batteries, lithium-ion secondary batteries, supercapacitors, sodium-ion batteries, lithium-air batteries, and other electrochemical cells.

### Advantages and Improvements

The new concept of this invention is the in-situ synthesis of an electrochemically active material within a highly dispersed, highly conductive matrix. Prior state of the art employs post-synthesis mixing, meaning that the synthesis of the electrochemically active material is decoupled from the mixing with the conductive matrix; synthesis and mixing are two separate processes. Post-synthesis mixing generally is incapable of achieving a good dispersion and homogeneous mixture, and is often associated with the introduction of unwanted impurities. It is also a time-consuming and costly process that requires frequent exchange of grinding or milling tools such as balls for a ball-mill.

Prior state of the art results attempting pre-synthesis mixing have not been successful yet, due to the inability to fabricate the composite using other methods than the one described herein.

The novel concept of the in-situ synthesis of the electrochemically active material within the conductive matrix makes it possible to achieve a highly conducting percolated network within the active material composite, yielding exceptional electrochemical properties such as very stable cycling capacity and an unsurpassed power (i.e. unsurpassed capacity-retention after discharge at very high rates).

### Process Chart

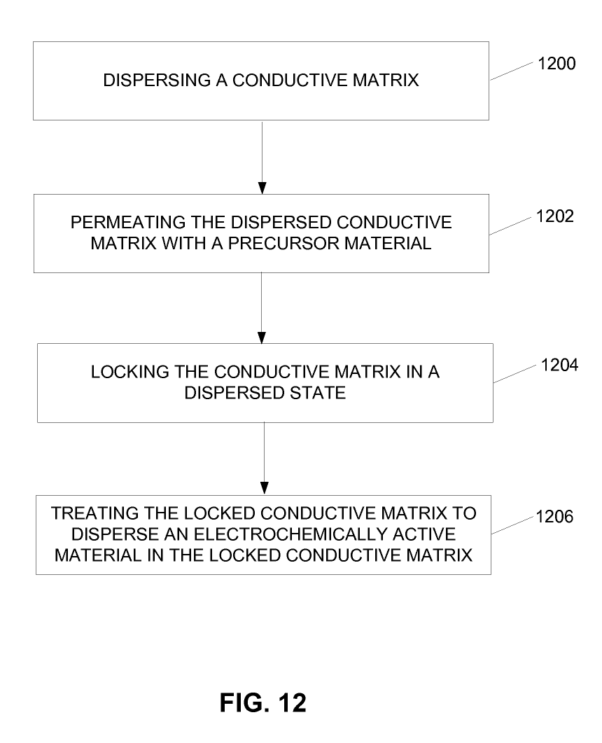

FIG. 12 illustrates a process chart in accordance with one or more embodiments of the present invention.

Box 1200 illustrates dispersing a conductive matrix.

Box 1202 illustrates permeating the dispersed conductive matrix with a precursor material.

Box 1204 illustrates locking the conductive matrix in a dispersed state.

Box 1206 illustrates treating the locked conductive matrix to disperse an electrochemically active material in the locked conductive matrix.

### REFERENCES

The following references are incorporated by reference herein:
i. http://electronics.howstuffworks.com/lithium-ion-battery1.htm
ii. http://www.bluenanoinc.com/products/battery-conductive-additives.html
iii. Chen, Y.-H. et al., 2007. Selection of Conductive Additives in Li-Ion Battery Cathodes. Journal of The Electrochemical Society, 154(10), p. A978.
iv. Ahn, S., 1999. Development of high capacity, high rate lithium ion batteries utilizing metal fiber conductive additives. Journal of Power Sources, 81-82(1-2), pp. 896-901.
v. Jin, B. et al., 2008. Effect of different carbon conductive additives on electrochemical properties of LiFePO4-C/Li batteries. Journal of Solid State Electrochemistry, 12(12), pp. 1549-1554.
vi. Wang, G. et al., 2007. LiNi0.8Co0.2O2/MWCNT composite electrodes for supercapacitors. Materials Chemistry and Physics, 105(2-3), pp. 169-174.
vii. Ban, C. et al., 2010. Extremely Durable High-Rate Capability of a LiNi0.4Mn0.4Co0.2O2 Cathode Enabled with Single-Walled Carbon Nanotubes. Advanced Energy Materials, p.n/a-n/a.
viii. Li, X. et al., 2007. A novel network composite cathode of LiFePO4/multiwalled carbon nanotubes with high rate capability for lithium ion batteries. Electrochemistry Communications, 9(4), pp. 663-666.
ix. Jin, B. et al., 2008. Electrochemical properties of LiFePO4-multiwalled carbon nanotubes composite cathode materials for lithium polymer battery. Electrochemistry Communications, 10(10), pp. 1537-1540.
x. Yue, H. et al., 2009. Hydrothermal synthesis of LiMn2O4/C composite as a cathode for rechargeable lithium-ion battery with excellent rate capability. Electrochimica Acta, 54(23), pp. 5363-5367.
xi. Liu, X.-M. et al., 2010. Sol-gel synthesis of multiwalled carbon nanotube-LiMn2O4 nanocomposites as cathode materials for Li-ion batteries. Journal of Power Sources, 195(13), pp. 4290-4296.
xii. Yue, H., Huang, X. & Yang, Y., 2008. Preparation and electrochemical performance of manganese oxide/carbon nanotubes composite as a cathode for rechargeable lithium battery with high power density. Materials Letters, 62(19), pp. 3388-3390.
xiii. Teng, F. et al., 2010. In-situ hydrothermal synthesis of three-dimensional MnO2/CNT nanocomposites and their electrochemical properties. Journal of Alloys and Compounds, 499(2), pp. 259-264.
xiv. U.S. Pat. No. 7,724,500, issued May 25, 2010, to Long, et al.
xv. U.S. Patent Application Publication No. 2009/0176159, filed Jan. 9, 2008, published Jul. 9, 2009, by Zhamu et al.

### CONCLUSION

This concludes the description of the preferred embodiments of the present invention. Although the present invention has been described in connection with the preferred embodiments, it is to be understood that modifications and variations may be utilized without departing from the principles and scope of the invention, as those skilled in the art will readily understand. Accordingly, such modifications would be practiced within the scope of the invention and the following claims, and the full range of equivalents of the claims.

The foregoing description of one or more embodiments of the invention has been presented for the purposes of illustration and description. It is not intended to be exhaustive or to limit the invention to the precise form disclosed. Many modifications and variations are possible in light of the above teaching.

The attached claims are presented merely as one aspect of the present invention. The Applicant does not disclaim any claim scope of the present invention through the inclusion of this or any other claim language that is presented herein or may be presented in the future. Any disclaimers, expressed or implied, made during prosecution of the present application regarding the claims presented, changes made to the claims for clarification, or other changes made during prosecution are hereby expressly disclaimed for at least the reason of recapturing any potential disclaimed claim scope affected by presentation of specific claim language during prosecution of this and any related applications. Applicant reserves the right to file broader claims, narrower claims, or claims of different scope or subject matter, in one or more continuation or divisional applications in accordance within the full breadth of the present disclosure, and the full range of doctrine of equivalents of the present disclosure, as recited in this specification.

What is claimed is:

1. A method of introducing electrochemical materials in situ, comprising:
dispersing a conductive matrix;
permeating the dispersed conductive matrix with a precursor material;
locking the conductive matrix in a dispersed state; and
treating the locked conductive matrix to disperse an electrochemically active material in the locked conductive matrix.

2. The method of claim 1, wherein the precursor material is used to synthesize the electrochemically active material.

3. The method of claim 1, wherein treating the locked conductive matrix comprises transforming the precursor material into the electrochemically active material.

4. The method of claim 1, wherein the electrochemically active material is dispersed in a uniform manner in the locked conductive matrix.

5. The method of claim 1, wherein the conductive matrix is a material selected from a group comprising: carbon nanotubes, can also comprise one or more of Multi-Walled Carbon Nanotubes (MWCNTS), Double-Walled Carbon Nanotubes (DWCNTs), Single-Walled Carbon Nanotubes (SWCNTs), Carbon Black, Acetylene Black, Super P, Carbon nanofibers, Graphene, and Graphite.

6. The method of claim 1, wherein the electrochemically active material is a material selected from a group comprising LiMn₂O₄, LiNiₓMn₂₋ₓO₄, LiFePO₄, LiMnPO₄, LiCoPO₄, LiNiₓCo_{y}Al_{z}O₂, LiCoO₂, LiMnₓCo_{y}Ni_{z}O₂, and Li₄Ti₅O₁₂.

7. The method of claim 1, wherein the conductive matrix is dispersed using sonication.

8. The method of claim 1, further comprising filtering the treated locked conductive matrix.

9. The method of claim 8, further comprising drying the filtered, treated, locked conductive matrix.

10. The method of claim 1, wherein the electrochemically active material comprises one or more of a nanocrystalline electrochemically active metal oxide, a microcrystalline electrochemically active metal oxide, and a metal phosphate.

11. The method of claim 1, wherein the treated locked conductive matrix comprises a cathode of an electrochemical cell.

12. A cathode for an electrochemical device, comprising
a conductive matrix; and
an electrochemically active material, coupled to the conductive matrix, wherein a precursor locks the conductive matrix in a dispersed state such that the electrochemically active material is distributed in the dispersed conductive matrix.

13. The cathode of claim 12, wherein the electrochemical device comprises a lithium-ion battery.

14. The cathode of claim 12, wherein the conductive matrix is a material selected from a group comprising: carbon nanotubes, can also comprise one or more of Multi-Walled Carbon Nanotubes (MWCNTS), Double-Walled Carbon Nanotubes (DWCNTs), Single-Walled Carbon Nanotubes (SWCNTs), Carbon Black, Acetylene Black, Super P, Carbon nanofibers, Graphene, and Graphite.

15. The cathode of claim 12, wherein the electrochemically active material is a material selected from a group comprising LiMn₂O₄, LiNiₓMn₂₋ₓO₄, LiFePO₄, LiMnPO₄, LiCoPO₄, LiNiₓCo_{y}Al_{z}O₂, LiCoO₂, LiMnₓCo_{y}Ni_{z}O₂, and Li₄Ti₅O₁₂.

16. The cathode of claim 12, wherein the electrochemically active material is homogeneously distributed within the dispersed conductive matrix.

17. The cathode of claim 12, wherein the precursor is used to synthesize the electrochemically active material.

18. The cathode of claim 12, wherein the precursor is transformed into the electrochemically active material.
